(19) United States
(12) Patent Application Publication
(10) Pub. No.: US 2026/0305858 A1
(43) Pub. Date: Oct. 8, 2026

(54) AUTOMATED SECURE PACKAGE DELIVERY AND STORAGE SYSTEM WITH INTEGRATED AERIAL VEHICLE SUPPORT

(71) Applicant: Aaron Haley, Littleton, CO (US)

(72) Inventor: Aaron Haley, Littleton, CO (US)

(21) Appl. No.: 19/639,240

(22) Filed: Apr. 5, 2026

Related U.S. Application Data
(60) Provisional application No. 63/783,640, filed on Apr. 4, 2025.

(51) Int. Cl. A47G 29/22; A47G 29/30; B64U 70/95; B64U 80/25

(52) U.S. Cl. CPC A47G 29/22; A47G 29/30; B64U 70/95; B64U 80/25

(57) ABSTRACT

An automated package delivery and storage system includes a vertical support structure extending approximately twelve feet high with a dome-shaped roof and movable containment vessel. The containment vessel travels vertically between a raised secure position and a lowered delivery position through an articulating mechanism. The system incorporates wireless controls for both traditional delivery personnel and autonomous aerial vehicles, while providing weather protection and security features. Solar power collection and battery storage enable sustainable operation and aerial vehicle charging capabilities. The system can be installed in various property locations while maintaining security and accessibility for authorized delivery operations.

### CROSS REFERENCE TO RELATED APPLICATIONS

This nonprovisional patent application claims priority to and the benefit of U.S. Provisional Patent Application No. 63/783,640, filed Apr. 4, 2025, titled “AUTOMATED SECURE PACKAGE DELIVERY AND STORAGE SYSTEM WITH INTEGRATED AERIAL VEHICLE SUPPORT,” the entire contents of which are incorporated herein by reference.

### BACKGROUND OF THE INVENTION

Package delivery to residential and commercial locations faces numerous challenges in the modern era that require innovative solutions. When packages are delivered to homes, they are frequently exposed to adverse weather conditions including rain, snow, and extreme temperatures, which can damage or destroy valuable items. Additionally, packages left unattended at delivery locations are increasingly vulnerable to theft, with package theft incidents rising dramatically in recent years as online shopping becomes more prevalent.

Current delivery methods predominantly rely on human delivery drivers and trucks, which represent a significant operational cost in terms of both labor and vehicle maintenance. These traditional delivery methods are particularly inefficient in rural areas where homes are located far apart, resulting in increased time, fuel consumption, and resources per delivery. The inefficiencies of traditional delivery methods become even more pronounced during peak delivery seasons and in areas with challenging terrain or limited accessibility.

While drone delivery technology offers promising solutions for package delivery, several substantial obstacles prevent widespread implementation. Current drone delivery testing is geographically limited to regions with favorable weather conditions, such as Arizona, due to the lack of weather-protected delivery locations in other areas. Additionally, the absence of standardized package placement locations for drone deliveries creates inconsistency, potential security risks, and operational challenges that impede broader adoption of this technology.

Another significant challenge in drone-based delivery systems is power management and infrastructure. Drones require frequent recharging to maintain operation, yet optimal delivery locations may not be situated near conventional power sources. Furthermore, when relying on alternative power sources, maintaining consistent power availability during nighttime hours and inclement weather presents additional complications that must be addressed for reliable service. The lack of standardized charging infrastructure creates further barriers to widespread drone delivery implementation.

The challenges of secure package delivery are further complicated in properties with backyards, where more secure delivery options may be desirable but are currently not readily available. Traditional delivery methods typically limit package placement to front porches or doorsteps, potentially exposing packages to greater risk of theft or weather damage. This limitation fails to utilize potentially more secure delivery locations that could better protect delivered items.

The current state of package delivery also presents challenges in standardization across different delivery services and methods. With multiple carriers and delivery technologies operating simultaneously, the lack of standardized delivery protocols and infrastructure creates inefficiencies and complications for both service providers and recipients. This fragmentation in delivery methods and protocols increases costs and reduces the overall effectiveness of package delivery systems.

These various challenges in the package delivery industry create an urgent need for innovative solutions that can address security concerns, weather protection requirements, power management issues, and standardization needs while simultaneously reducing operational costs and improving delivery efficiency. The industry requires solutions that can adapt to various property configurations, weather conditions, and delivery methods while maintaining security and reliability throughout the delivery process.

### SUMMARY OF THE INVENTION

An embodiment of the invention provides an automated package delivery and storage system comprising a vertical support structure with an integrated containment vessel that can be selectively raised and lowered to facilitate secure package delivery and retrieval. The system incorporates both traditional delivery access methods and drone delivery capabilities while providing weather protection and security features.

In a preferred embodiment, the system includes a vertical pole assembly extending approximately twelve feet in height, topped with a dome-shaped roof structure covering a movable containment vessel. The containment vessel can be lowered approximately three to four feet from its secured position to receive packages, then raised back under the protective dome roof. The movement is facilitated through a motorized lifting mechanism utilizing cables and guide systems integrated into the vertical support structure.

An example of the invention incorporates wireless control systems enabling authorized access through personal FOB devices, delivery service authentication, and drone delivery interfaces. The system may include standardized charging capabilities through solar power collection and battery storage, providing both operational power and drone recharging capabilities.

The preferred embodiment includes security features through its elevated design, while maintaining accessibility for authorized users. Weather protection is achieved through sealed construction methods and protective coverings, with the containment vessel providing a secure, weather-resistant storage location when in its raised position.

The invention provides solutions for both traditional and automated delivery methods while incorporating sustainable power management features. The system can be configured for various property locations, including both front yard and backyard installations, providing flexibility in deployment while maintaining security and accessibility for authorized delivery operations.

### BRIEF DESCRIPTION OF THE FIGURES

FIG. 1 illustrates a side view of the automated package delivery and storage system in an embodiment, showing the vertical support structure, collar, dome-shaped roof structure, containment vessel, and solar panel.

FIG. 2 depicts a side view of the system in its secured position in accordance with an embodiment, with the containment vessel raised to engage with the dome-shaped roof structure atop the vertical support structure, with the collar in its elevated position.

FIG. 3 shows the system in an embodiment during a delivery operation, with a delivery vehicle approaching the containment vessel which is positioned at its lowered height along the vertical support structure.

FIG. 4 illustrates operation of the system in an embodiment via wireless control, depicting a mobile device sending wireless signals to actuate the containment vessel's movement along the vertical support structure.

FIG. 5 shows the system in an embodiment during an aerial delivery operation, featuring an aerial delivery vehicle approaching the containment vessel positioned at an intermediate height. The figure also depicts the charging interface and solar panel integrated into the dome-shaped roof structure.

FIG. 6 demonstrates the aerial delivery vehicle utilizing the charging interface while positioned near the dome-shaped roof structure in accordance with an embodiment, with the containment vessel in its secured position.

FIG. 7 depicts the containment vessel positioned at an intermediate height along the pole with a drone delivering a package into the containment vessel in accordance with an embodiment.

FIG. 8 presents a view of the system in an embodiment highlighting the integration of additional features, including the charging interface and solar panel, with the containment vessel secured beneath the dome-shaped roof structure.

### DETAILED DESCRIPTION OF THE INVENTION

An embodiment of the invention provides an automated package delivery and storage system that enables secure delivery and storage of packages through both traditional and drone-based delivery methods. The system includes a vertically-oriented structure with an adjustable containment vessel that can be raised and lowered to facilitate package delivery and retrieval. In a preferred embodiment, the system incorporates power management capabilities to support drone operations and charging.

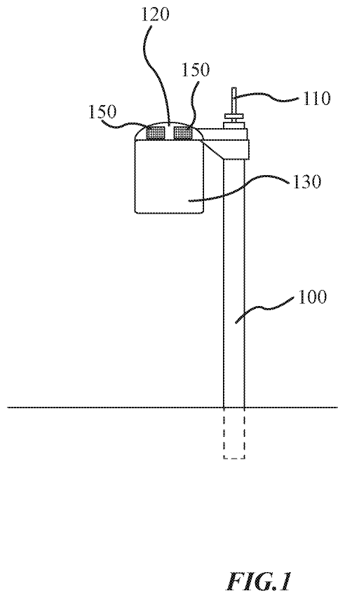

As shown in FIG. 1, the automated package delivery and storage system in an embodiment comprises a vertical support structure (100) that extends upward from the ground surface. A collar (110) is moveably coupled to the vertical support structure, enabling vertical translation along its length. The dome-shaped roof structure (120) is fixedly attached to the upper terminus of the vertical support structure, while the containment vessel (130) is affixed to the collar to enable vertical movement. A solar panel (150) is integrated into the dome-shaped roof structure to provide sustainable power for system operation.

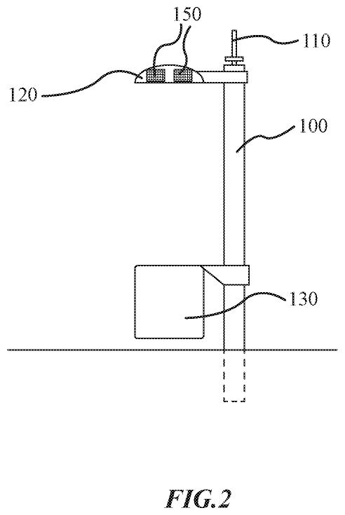

FIG. 2 illustrates the system in its secured configuration in an embodiment, with the containment vessel (130) raised to its weather-protected position beneath the dome-shaped roof structure (120). The collar (110) maintains the containment vessel's elevated position through engagement with the vertical support structure (100).

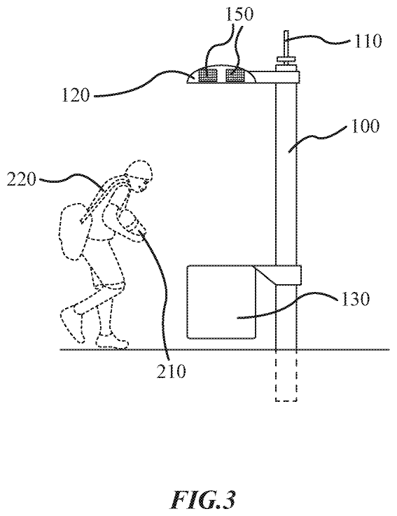

As depicted in FIG. 3, the system in an embodiment accommodates ground-based delivery operations when the containment vessel (130) is lowered along the vertical support structure (100). A delivery vehicle (200) can approach the system to place a package (210) into the containment vessel.

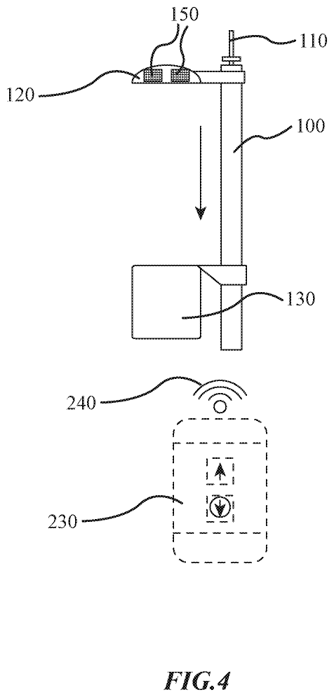

FIG. 4 demonstrates the wireless control capabilities of the system in an embodiment, showing a mobile device (230) transmitting control signals to actuate the containment vessel's (130) vertical movement along the support structure (100).

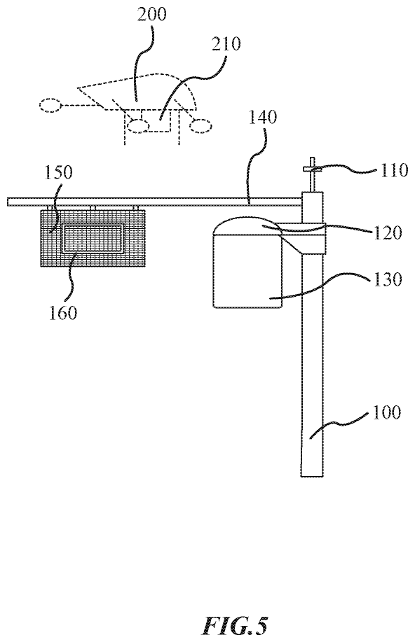

FIG. 5 illustrates the system in an embodiment during aerial delivery operations, featuring an aerial delivery vehicle (200) approaching the containment vessel (130) positioned at its intermediate height. The charging interface (160) and solar panel (150) are integrated into the dome-shaped roof structure (120) to support aerial vehicle operations.

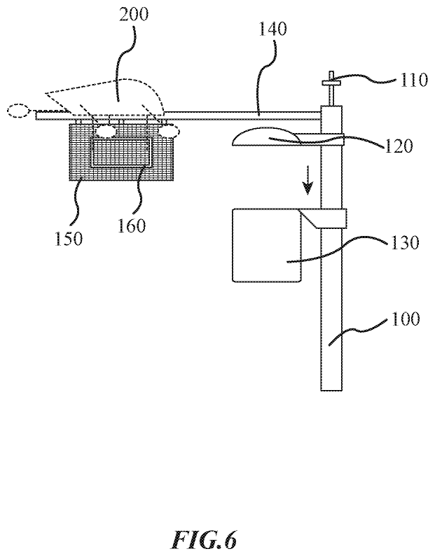

As shown in FIG. 6, in an embodiment the aerial delivery vehicle (200) can utilize the charging interface (160) while positioned near the dome-shaped roof structure (120). During charging operations, the containment vessel (130) remains in its secured position beneath the dome-shaped roof.

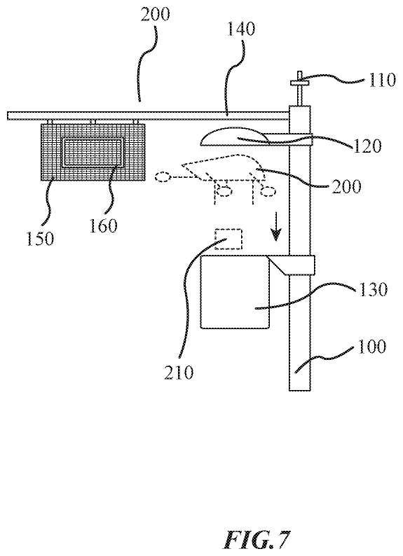

FIG. 7 illustrates the containment vessel (130) positioned at an intermediate height along the pole for receiving aerial deliveries, with a drone shown in the process of depositing a package into the containment vessel. This intermediate position functionality enables the containment vessel to stop part way down the pole to receive air deliveries from drones before automatically returning to its docking position under the cap. The system's ability to position the containment vessel at this specific height facilitates secure and efficient drone-based package delivery operations, with the drone able to safely transfer its cargo into the waiting containment vessel.

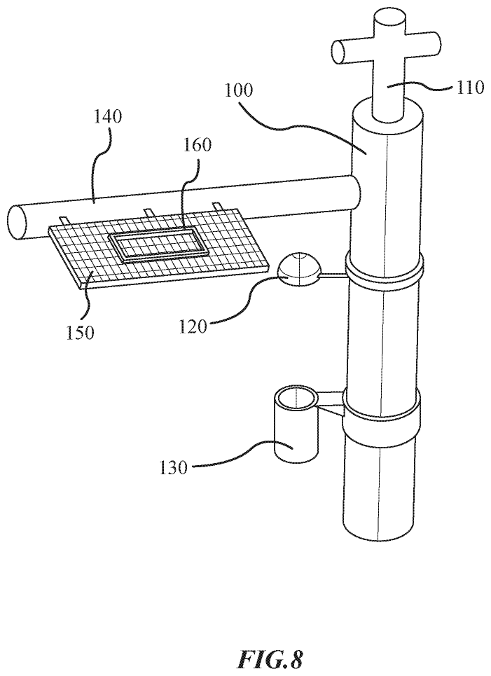

FIG. 8 provides a detailed view of the system's integrated features in an embodiment, highlighting the charging interface (160) and solar panel (150) configurations, while showing the containment vessel (130) in its weather-protected position beneath the dome-shaped roof structure (120).

In a preferred embodiment, the automated package delivery and storage system comprises four major components: a pole (also referred to herein and in various figures as a vertical support structure (100)), a collar (110), a basket (130), and a cap (also referred to herein and in various figures as a dome-shaped roof structure (120)). The pole component comprises the vertical support structure that is fixedly attached to the ground in a vertical orientation. The collar component is moveably joined to the pole such that it can slide vertically up and down along the pole's length. The basket component is affixed to the collar, enabling the basket to travel vertically with the collar's movement along the pole. The cap component is fixedly attached to the upper terminus of the pole.

The cap component serves dual purposes in the system's operation. First, it functions as a weather-resistant docking station for the basket when the basket is in its raised position. Second, the cap houses the drive system that enables the vertical movement of the collar and basket assembly. The drive system may be mechanical, utilizing an electric motor, or may alternatively employ hydraulic or pneumatic mechanisms to achieve the vertical movement.

The invention, in one example, comprises a weather-resistant structure that extends vertically from a ground-mounted base to an elevated height sufficient to prevent unauthorized access. A preferred embodiment includes a covered containment area at the upper portion of the structure, with the containment area being selectively movable between an elevated secure position and a lowered delivery position. The system may be configured to receive wireless control signals from authorized delivery personnel and autonomous delivery vehicles to facilitate package transfer operations.

In an example of the invention, the structure incorporates sustainable power management features that enable both off-grid operation and support for aerial delivery vehicle charging needs. The system can be configured for installation in various locations on a property, including both front yard and backyard placements, providing flexibility in deployment while maintaining security and accessibility for authorized delivery operations.

In a preferred embodiment of the invention, the primary structure comprises a vertical support assembly extending approximately twelve feet in height from a ground-mounted base. The vertical support may be constructed from weather-resistant materials such as galvanized steel, aluminum, or reinforced composite materials capable of withstanding environmental conditions while maintaining structural integrity. The vertical support assembly may be sectional to facilitate shipping and assembly, with sections joining together via internal coupling mechanisms and securing bolts.

The solar power collection system, battery storage unit, and drone charging interface are integrated into the dome-shaped roof structure and the upper portion of the vertical support structure as a unified power architecture. In a preferred embodiment, the photovoltaic panels are mounted on or within the exterior surface of the dome-shaped roof structure in a configuration that maximizes solar exposure across the daily sun arc, and the battery storage unit is housed in a weather-sealed compartment within the vertical support structure at a location accessible for maintenance without disassembly of the dome-shaped roof structure. The charging interface provides electrical power to aerial delivery vehicles docked at or near the dome-shaped roof structure and is configured to support multiple charging protocols to accommodate a range of aerial vehicle platforms. Supported protocols in a preferred embodiment include USB-C Power Delivery at power levels up to 240 watts, aviation-specific wired connectors incorporating keying features, locking mechanisms, and environmental sealing, Qi inductive charging for smaller aerial vehicles, and Rezence resonant inductive coupling for applications requiring greater charging range or tolerance in docking alignment. The charging interface may further support communication protocols including CAN bus communication through aviation-specific wired connectors to allow the aerial vehicle and the charging interface to exchange battery state-of-charge data, charging parameter negotiation, and safety interlock signals. The multi-modal power architecture of the present invention, in which solar collection, battery storage, and drone charging are all integrated into a single standalone pole-mounted structure, creates a distributed power node for residential logistics operations that is not disclosed or suggested by prior art systems that separately address ground-level smart mailboxes with solar capabilities and drone charging bases that are independent of the delivery receptacle structure.

The vertical support structure in an exemplary embodiment extends approximately twelve feet (144 inches) in height from the ground surface, placing the containment vessel and package storage area at an elevation that provides multiple security and operational benefits.

The twelve-foot height positions the containment vessel beyond practical reach without authorized access mechanisms, serving as a primary theft-deterrent feature. This elevation prevents unauthorized individuals from accessing packages even when using common tools or ladders, while the vertical support structure incorporates smooth surfaces and anti-climbing features to further deter tampering attempts.

For drone delivery operations, the twelve-foot height associated with an exemplary embodiment provides sufficient clearance above typical ground-level obstacles encountered in residential settings. This elevation allows aerial delivery vehicles to safely navigate above standard residential fencing (typically 4-6 feet), landscaping features, and lower tree branches (often pruned to 8-10 feet) during approach and departure maneuvers. The dome-shaped roof structure at this height serves as a clear visual marker for drone navigation while providing weather protection.

While the twelve-foot height represents a preferred embodiment, alternative heights may be suitable based on specific installation requirements and local conditions. The vertical support structure could be constructed at heights ranging from approximately ten to fifteen feet to accommodate varying security needs and property configurations. Lower heights may be appropriate for installations with additional security features or in controlled access areas, while greater heights could provide enhanced drone clearance in locations with taller obstacles or vegetation. These alternative heights would maintain the core functionality of elevating the containment vessel beyond practical reach while requiring corresponding adjustments to the articulating mechanism's travel range and structural components to ensure stable operation. The selection of alternative heights would consider factors such as local building codes, property characteristics, and specific security requirements while maintaining the system's fundamental capabilities for secure package delivery and storage.

The containment vessel's vertical travel range of approximately three to four feet from its secured position maintains the lower access point at a minimum height of 8-9 feet above ground level during package transfer operations. This ensures that even in its fully lowered position, the system remains at a secure height while still allowing efficient access for authorized delivery personnel and aerial vehicles.

The stabilization supports positioned near the dome-shaped roof provide temporary mechanical stability for aerial delivery vehicles during package transfer operations at the twelve-foot elevation. These supports include cushioned rest pads and visual guidance markers to facilitate precise drone positioning at this operational height.

While the dome-shaped roof represents a preferred embodiment, alternative roof configurations in accordance with alternative embodiments of the invention may include pyramidal structures, gabled designs, or multi-faceted geometric shapes that maintain weather protection while accommodating various architectural preferences and functional requirements. These alternative roof structures can be constructed from impact-resistant transparent or translucent materials to maintain visual package confirmation capabilities.

The weather-tight seal between the containment vessel and roof structure in accordance with various embodiments is achieved through multiple mechanisms. One approach utilizes complementary geometries where the containment vessel's upper edges precisely mate with corresponding surfaces on the roof structure, incorporating flexible gasket materials to ensure complete closure. Alternative sealing mechanisms may include overlapping lip designs with water-channeling features, compression-based sealing systems utilizing spring-loaded elements, or multi-stage sealing arrangements combining rigid and flexible components.

The sealing system may incorporate overlapping seams and water-resistant seals with multiple layers, including an outer impact-resistant shell and inner moisture barrier. These sealing elements can be enhanced with drainage features to prevent water accumulation and flexible protective elements around the perimeter that maintain seal integrity while allowing smooth operation of the containment vessel.

The secure position can be maintained through both mechanical locks and gravity-based positioning, with the sealing mechanism potentially incorporating automatic tensioning elements to ensure consistent seal pressure across varying environmental conditions. The system may include sensors to verify proper seal engagement and monitor seal integrity during operation.

At the upper terminus of the vertical support, a dome-shaped roof structure provides weather protection for the containment area. The dome roof, in one example of the invention, comprises impact-resistant transparent or translucent material to allow visual confirmation of package presence while protecting contents from precipitation and direct sunlight. The dome structure may be permanently affixed to the vertical support or may be removable for maintenance access.

The movable basket/containment vessel operates within the vertical support assembly, configured to travel vertically along guide rails or channels integrated into the support structure. In an embodiment of the invention, the containment vessel includes reinforced corners and edges to maintain structural integrity during repeated raising and lowering operations. The containment vessel dimensions may be standardized to accommodate common package sizes while maintaining compatibility with drone delivery requirements.

The basket component may be constructed from any suitable material that fulfills its functional requirements, including but not limited to metal, plastic, cloth, wood, or combinations thereof. The selection of basket construction materials may be optimized based on specific deployment requirements, environmental conditions, and load-bearing needs while maintaining the system's core functionality for secure package storage and protection.

Similarly, the cap component offers flexibility in both material selection and geometric configuration. The cap may be constructed from any material that provides the required structural integrity and weather protection while housing the drive system. The shape of the cap may vary from the dome configuration described in the preferred embodiment to alternative geometric forms, provided the chosen design maintains its dual functionality as a weather-resistant docking station and drive system housing.

Side walls extending along the vertical support assembly provide guidance and protection for the containment vessel during vertical movement. These walls, in a preferred embodiment, incorporate weather-resistant seals and overlapping edges to prevent moisture intrusion while allowing smooth operation of the moving components. The side walls may include integrated channels for housing control wiring and mechanical components.

The articulating mechanism enabling vertical movement comprises, in one example of the invention, a motorized winch system with high-strength cables or chains connecting to the containment vessel. The mechanism includes safety features such as automatic stops, emergency manual operation capability, and position sensors to monitor vessel location. In a preferred embodiment, the articulating mechanism incorporates redundant support systems to prevent uncontrolled descent in case of primary system failure.

In an embodiment of the invention, the basket system comprises a containment area approximately the size of a standard basketball hoop, providing sufficient capacity for typical residential package deliveries while maintaining compatibility with drone delivery capabilities. The containment area may be constructed from high-strength, lightweight materials such as reinforced polymers or aluminum alloys to optimize the load-bearing capacity while minimizing the power requirements for vertical movement.

The weather-protective walls of the containment area, in a preferred embodiment, incorporate overlapping seams and water-resistant seals to prevent moisture intrusion. These walls may be constructed with multiple layers, including an outer impact-resistant shell and an inner moisture barrier, to provide protection for package contents. The walls may also include drainage features to prevent water accumulation.

An example of the invention includes an upward-facing opening sized to accommodate standard package dimensions while facilitating drone package release operations. The opening may incorporate flexible protective elements around its perimeter to allow package insertion while minimizing weather exposure. In one embodiment, the opening includes sensors to detect package presence and trigger automatic raising operations.

The containment area in an exemplary intended method of use is designed to travel vertically approximately 3-4 feet from its resting position at the top to facilitate package loading and retrieval. A preferred embodiment incorporates smooth-action guide mechanisms and balanced weight distribution to ensure stable movement throughout the travel range. The movement system may include programmable stop positions to accommodate different delivery scenarios and user preferences.

The containment vessel is configured to stop at an intermediate position part way down the pole to facilitate aerial package deliveries. When receiving packages from aerial delivery vehicles such as drones, the containment vessel descends from its weather-protected docking position at the cap to this intermediate position along the vertical support structure. After the aerial delivery vehicle deposits its package into the containment vessel at this intermediate position, the vessel returns to its secured docking position under the cap.

This intermediate stopping position provides an optimal height for drone package transfers while maintaining security benefits of the elevated design. Once the aerial delivery is complete and the containment vessel returns to its docking position, the package remains protected from weather and unauthorized access. The system's control mechanisms enable precise positioning at this intermediate height through integrated position sensors and automated movement controls.

When raised to its top position, the containment area forms a weather-tight seal with the roof structure. In an example of the invention, this seal is achieved through complementary geometries between the containment area's upper edges and the dome structure, potentially incorporating flexible gasket materials to ensure complete closure. The secure position may be maintained through both mechanical locks and gravity-based positioning to prevent unauthorized access to the contents.

The weather-tight sealing interface between the containment vessel and the dome-shaped roof structure is a functional element that operates passively through the upward movement of the containment vessel rather than through the independent actuation of a separate cover mechanism. The dome-shaped roof structure is fixed and stationary, and the containment vessel rises to meet it. The act of raising the containment vessel to the secured docking position is simultaneously the act of completing the weather seal. In a preferred embodiment, the sealing interface comprises a first sealing surface defined by the upper perimeter geometry of the containment vessel and a second sealing surface defined by a receiving flange or socket geometry on the lower face of the dome-shaped roof structure. A compressible gasket element, constructed of a weather-resistant elastomeric material, is retained in a channel in one or both of the mating surfaces and is compressed between the surfaces when the containment vessel reaches the secured docking position, creating a continuous seal around the entire perimeter of the containment vessel opening. The seal may be further supplemented by an overlapping lip arrangement that channels precipitation away from the sealed joint and toward drainage features integrated into the exterior of the vertical support structure. The automatic nature of the sealing engagement means that weather protection is always restored upon the completion of any delivery event without requiring any action by the property owner, delivery personnel, or control system beyond the command to raise the containment vessel. This automatic restoration eliminates the mechanical complexity and potential failure modes associated with a separately driven cover and reduces the risk of packages remaining exposed to weather due to failure to actuate an independent cover mechanism.

In a preferred embodiment of the invention, the movement mechanism incorporates a motorized lifting system that operates similarly to a heavy-duty fishing reel mechanism. The motorized system may include a geared electric motor with variable speed control, automatic braking capabilities, and integrated torque limiters to ensure precise and controlled movement of the containment vessel. The motor assembly may be housed in a weather-resistant enclosure integrated into the vertical support structure, with access panels for maintenance and manual override operations. The motor control system may include programmable acceleration and deceleration profiles to optimize movement smoothness and minimize wear.

Alternative embodiments of the invention may incorporate several different lifting mechanisms to achieve vertical movement of the containment vessel. A pulley-based system provides a simple and reliable method particularly suited for lighter basket configurations, utilizing a rope attached to the containment vessel running over a pulley at the top of the pole. This configuration can be enhanced with a locking mechanism to secure the basket position.

For applications requiring greater lifting capacity, a hydraulic system may be employed, utilizing hydraulic fluid and a pump to generate force for lifting the containment vessel. This configuration offers smooth and precise movement control while maintaining the ability to handle heavier loads. The hydraulic cylinder extends to raise the basket, with a valve system providing movement control.

A manual or motorized winch system represents another alternative embodiment, utilizing a mechanical device with a drum and cable or rope configuration for lifting operations. This system offers strong lifting capacity and reliable operation, particularly suitable for heavier containment vessel designs.

The invention in an embodiment may alternatively employ a rack and pinion system, where a toothed rack fixed to the pole engages with a pinion gear to facilitate vertical movement. This configuration provides precise linear movement and can effectively handle moderate loads while maintaining operational reliability.

A lead screw system represents another alternative embodiment, utilizing a rotating lead screw with a traveling nut attached to the containment vessel. This configuration can be manually or motor-driven and provides a strong and stable lifting mechanism for the system.

For lighter to moderate load applications, a pneumatic system utilizing compressed air to power a pneumatic cylinder offers an alternative lifting mechanism. This configuration provides fast and efficient movement while maintaining operational simplicity.

The selection of these alternative lifting mechanisms considers factors including the anticipated weight of the containment vessel and its contents, required lifting speed, movement precision requirements, cost considerations, ease of operation, and ongoing maintenance requirements. Each alternative mechanism can be integrated into the vertical support structure with appropriate weather-resistant enclosures and access panels for maintenance, while incorporating necessary safety features and control systems to ensure reliable operation.

The cable system, in an example of the invention, utilizes high-strength cables constructed from materials such as aircraft-grade steel or synthetic materials designed for repeated lifting operations. The cables may be configured in a redundant arrangement, with multiple cables supporting the containment vessel to provide fail-safe operation. In one embodiment, the cables incorporate wear indicators, tension monitoring systems, and automatic cable tensioning mechanisms to facilitate maintenance scheduling and ensure optimal performance. The cable routing system may include specially designed pulleys with sealed bearings and cable guides to prevent tangling or misalignment during operation.

The hydraulic/mechanical articulation components may include, in a preferred embodiment, a combination of mechanical linkages and hydraulic assist mechanisms to provide smooth operation and emergency manual override capabilities. These components may be designed with sealed bearings, weather-resistant materials, and redundant sealing systems to ensure reliable operation in various environmental conditions. The hydraulic system may incorporate pressure relief valves, flow regulators, and accumulator systems to maintain consistent movement speeds and provide emergency power for lowering operations. The mechanical components may include dampening elements to reduce vibration and shock loading during movement.

An embodiment of the invention includes a vertical guide system integrated along the support pole, featuring precision-machined tracks or channels that maintain proper alignment of the containment vessel during vertical travel. The guide system may incorporate low-friction materials or roller bearings to minimize operational wear while ensuring smooth movement. In one example, the guide system includes integrated position sensors to monitor the location of the containment vessel and control its movement limits. The guide system may also incorporate self-cleaning mechanisms to prevent debris accumulation and maintain reliable operation in various weather conditions. Additional safety features may include mechanical stops, emergency braking mechanisms, and redundant position sensing to prevent over-travel in either direction.

The movement mechanism may also incorporate diagnostic and monitoring systems that provide real-time feedback on system performance, component wear, and maintenance requirements. These systems may include temperature sensors, load cells, and motion sensors that can detect abnormal operation and trigger appropriate safety responses. The control system may include remote monitoring capabilities to allow for preventive maintenance scheduling and system optimization based on usage patterns.

In a preferred embodiment of the invention, the control systems incorporate wireless actuation capabilities utilizing secure radio frequency or cellular communications protocols. The wireless system may include encrypted transmission methods and rolling security codes to prevent unauthorized access while enabling legitimate operation from authorized devices. The control system may incorporate multiple redundant wireless receivers to ensure reliable operation regardless of signal direction or environmental conditions.

The system supports multiple methods of operation to provide flexibility in controlling the containment vessel's movement. Manual operation allows direct control of the lifting mechanism through physical controls integrated into the system structure. This manual control capability ensures system functionality even in situations where wireless control methods are unavailable.

A FOB control interface provides wireless actuation through a handheld device. The FOB incorporates dedicated control buttons for raising and lowering operations, with visual feedback elements confirming successful operation. Multiple FOBs may be registered to a single system, enabling access for authorized users while maintaining security through encrypted transmission methods.

Cell phone control is enabled through a secure software application designed for mobile devices. This interface provides authenticated access through biometric verification or secure login credentials, allowing remote operation of the containment vessel's lifting mechanism. The mobile interface includes dedicated controls for raising and lowering operations, with real-time status updates and visual confirmation of successful operations.

Automated drone activation enables the system to respond to authenticated aerial delivery vehicles without requiring manual intervention. This automation integrates with standardized drone communication protocols to verify authorized delivery vehicles and control the containment vessel's movement to appropriate positions for package transfer operations. The automated system includes status feedback regarding containment vessel position and availability, while maintaining compatibility with various drone delivery platforms.

The FOB control interface, in an example of the invention, comprises a handheld device with dedicated control buttons for raising and lowering operations. The FOB may incorporate visual feedback elements such as LED indicators to confirm successful operations and battery status. In one embodiment, the FOB utilizes replaceable batteries and includes low-battery warning features to prevent operation interruption. The system may support multiple registered FOBs with individual identification codes for access tracking.

In a preferred embodiment of the invention, the FOB control interface comprises a handheld wireless device approximately the size of a typical car key fob, incorporating raised tactile buttons for raising and lowering operations of the containment vessel. The FOB may utilize a secure rolling-code transmission system operating at 315 MHz or 433 MHz frequencies, similar to those used in automotive applications, with 128-bit encryption to prevent signal interception or duplication. The device includes visual feedback through multi-color LED indicators that confirm successful transmission, operation completion, and battery status, with the LED changing from green to red when battery voltage drops below a predetermined threshold. The FOB housing may be constructed of impact-resistant ABS plastic with rubber button covers and gasket sealing to achieve an IP65 weather resistance rating, powered by a common CR2032 battery accessible via a secured battery compartment. The control interface can be programmed to the base unit through a secure pairing process, with each FOB storing a unique identification code in non-volatile memory to enable tracking of access events and allowing the system to support up to 8 registered FOBs simultaneously.

In an alternative embodiment, the system incorporates a mobile device control interface utilizing a secure software application designed for smartphones and tablets. The application provides authenticated access through biometric verification or secure login credentials, enabling remote operation of the containment vessel's lifting mechanism through encrypted wireless communications.

The mobile interface includes dedicated virtual controls for raising and lowering operations, with real-time status updates and visual confirmation of successful operations displayed on the device screen. The system maintains compatibility with various mobile operating systems while incorporating similar security protocols to the FOB system, including 128-bit encryption and rolling security codes to prevent unauthorized access.

For delivery personnel, the system provides temporary access through a specialized delivery service interface within the mobile application. This interface generates time-limited authentication codes for specific delivery windows, automatically logging and tracking all delivery operations with timestamp and service identification data. The delivery interface includes visual indicators and status updates to confirm successful authentication and operation status.

The drone control interface integrates with the mobile platform through standardized communication protocols, including wireless communications methodologies as will be readily understood by those skilled in the art, thus enabling automated authentication procedures for verified delivery vehicles. This interface incorporates status feedback regarding containment vessel position and availability, while maintaining compatibility with various drone delivery platforms. The system includes optical markers or radio beacons to assist with drone positioning during delivery operations, with the mobile interface providing real-time monitoring of drone delivery status.

The mobile control system in an exemplary embodiment integrates with home automation systems, such as in an example Apple HomeKit and Nest systems, to provide instant delivery notifications and status updates to the property owner. The interface includes environmental monitoring capabilities, displaying real-time data about weather conditions and system status. Advanced features include remote system diagnostics, maintenance scheduling, and automated alerts for system events or potential security concerns.

A preferred embodiment includes a drone-compatible control system that can interface with various drone delivery platforms through standardized communication protocols. This system may incorporate optical markers or radio beacons to assist with drone positioning during delivery operations. The drone control interface may include automated authentication procedures to verify authorized delivery vehicles and reject unauthorized access attempts. The system may also provide status feedback to the drone system regarding containment vessel position and availability.

The system in an embodiment incorporates visual markers providing clear, unambiguous targets for drone camera systems and other drone systems to lock onto during final landing stages. These markers may include QR codes assigned to each landing location, ArUco markers designed for robust performance in challenging conditions, custom geometric patterns, or retroreflective materials that reflect light strongly for enhanced visibility in low-light conditions. The visual markers are prominently placed on the landing platform of the containment vessel to ensure visibility from above.

Radio beacon integration in an embodiment provides additional location identification capabilities, allowing drones to home in on the landing location before achieving visual range. The system may utilize Ultra-Wideband (UWB) beacons for high precision and interference resistance, Bluetooth Low Energy (BLE) beacons for shorter-range applications, or RFID tags embedded in the landing platform.

The location association system in an embodiment maintains a database that links each unique visual marker and radio beacon identifier to specific address information. This database includes GPS coordinates of each landing location along with corresponding marker/beacon identifiers, enabling address verification during drone navigation. Geofencing technology creates virtual boundaries around each landing location to assist drones in navigating to the general vicinity before utilizing the visual marker/radio beacon for precise landing.

The system in an embodiment implements a multi-layered approach where the drone first navigates using GPS coordinates to the general vicinity, then detects the radio beacon signal from the landing platform, and finally uses the camera system to identify the unique visual marker for precise landing positioning. This integrated approach ensures reliable and accurate delivery operations while maintaining security through encrypted database access and tamper-resistant marker designs.

The system in an embodiment incorporates security measures to prevent unauthorized access or manipulation of the database and landing platforms, while ensuring reliability across various weather conditions. The design maintains scalability to accommodate numerous landing locations and seamlessly integrates with drone navigation and control systems.

The delivery driver access controls, in an example of the invention, utilize secure wireless protocols compatible with standard delivery service equipment. These controls may include temporary access codes generated for specific delivery windows and automatically expiring after use. The system may maintain an access log of all delivery operations, including timestamp and delivery service identification. In a preferred embodiment, the delivery access system includes visual indicators to confirm successful authentication and operation status to delivery personnel.

In a preferred embodiment, the system integrates with existing delivery service mobile applications, allowing drivers to seamlessly access basket controls through their standard delivery interface. After successful authentication using temporary access codes, the mobile app displays a clear, user-friendly interface with buttons or controls for lowering the basket. The app provides visual confirmation of successful operations and real-time status updates regarding basket position.

For situations where mobile app integration is not feasible, the system in an embodiment may incorporate a dedicated keypad or touchscreen interface mounted near the basket system. Following authentication via the main system using temporary access codes, delivery personnel can enter secondary codes or interact with the touchscreen to initiate basket lowering operations. The interface displays clear instructions and operational status updates.

The system in an embodiment implements multiple layers of security controls, including verification of driver authorization before allowing basket operation, strict enforcement of designated delivery window limitations, and encrypted wireless communication between control devices and the basket system. All basket operations are logged with detailed information including timestamps, driver identification, and any system messages or errors.

The system in an embodiment maintains fail-safe protocols with manual override options for system malfunctions, while ensuring all override operations are properly logged and monitored. These security measures integrate with the existing temporary access code system while providing flexibility for various delivery scenarios and user preferences.

For enhanced security and operational safety, the system in an embodiment may implement a combination approach where the driver must first authenticate through the mobile app or keypad interface, then confirm the operation through a secondary physical control point on the basket system. This dual-verification method prevents accidental activation while maintaining efficient delivery operations.

The control systems may also incorporate environmental sensors to monitor weather conditions and adjust operation parameters accordingly. Integration with home automation systems may be included to provide delivery notifications and status updates to the property owner. The system may include backup power supplies to maintain control system operation during power outages, with automatic switching to ensure uninterrupted service.

In a preferred embodiment of the invention, the power and charging components include a solar collection system comprising photovoltaic panels mounted on or integrated into the dome roof structure. The solar panels may be arranged in an optimized configuration to maximize sun exposure throughout the day, potentially incorporating micro-inverter technology for enhanced efficiency during partial shading conditions. The panels may be protected by impact-resistant coating or covers while maintaining high light transmission properties. The solar collection system may also include automatic cleaning mechanisms and tilt adjustment capabilities to optimize collection efficiency across different seasons and weather conditions.

The system may incorporate various additional features to enhance its functionality beyond package delivery and storage. A solar charging system may be integrated into the structure to provide sustainable power for system operation. This solar charging capability can be complemented by drone recharging functionality, enabling the system to serve as a charging station for delivery drones during their routes.

The system's elevated design, reaching approximately twelve feet in height, provides an advantageous 360-degree vantage point for security and monitoring applications. This elevated position enables the integration of various monitoring and communication technologies, including cameras for surveillance, lighting systems for enhanced visibility and security, and a Wi-Fi interface for network connectivity and remote system control.

The cameras may be positioned to utilize the system's elevated height advantage, providing comprehensive surveillance coverage of the surrounding area. The lighting systems can be strategically placed to illuminate the delivery zone and surrounding property, enhancing both operational effectiveness and security capabilities. The Wi-Fi interface enables remote monitoring and control while facilitating communication with delivery vehicles and security systems.

The battery storage unit, in an example of the invention, utilizes lithium iron phosphate (LiFePO4) or similar high-cycle-life battery technology housed in a weather-sealed compartment within the vertical support structure. The battery system may incorporate smart charging controls, thermal management systems, and state-of-charge monitoring to optimize battery life and performance. In one embodiment, the battery storage capacity is sized to maintain system operation for a minimum of 72 hours without solar input. The battery management system may include cell balancing capabilities, advanced diagnostic monitoring, and predictive maintenance algorithms to ensure optimal battery longevity and performance reliability.

A drone recharging interface, in a preferred embodiment, includes a standardized connection point positioned near the top of the structure. This interface may incorporate self-aligning guides and automatic connection mechanisms to facilitate drone docking. The charging interface may include multiple contact points for redundancy and various charging protocols to accommodate different drone platforms. The system may incorporate sensors to verify proper connection and monitor charging status. Additional features may include wireless charging capabilities using inductive or resonant charging technologies, with automatic positioning assistance for optimal charging alignment.

The charging system in an embodiment may utilize various wired charging standards to accommodate different drone platforms. USB-C compatibility offers high power delivery capabilities up to 240 W with USB4, providing standardized charging for compatible drones. Aviation-specific connectors can be developed incorporating keying features, locking mechanisms, and environmental sealing for enhanced durability and safety. Industrial power connectors may be utilized for larger drones requiring higher power transfer capabilities.

For wireless charging implementations, the system in an embodiment incorporates Qi inductive charging standards, particularly suitable for smaller drones, with specific profiles adapted for drone applications. Alternative wireless approaches may utilize Rezence resonant inductive coupling technology, offering greater range and potentially higher power transfer than traditional Qi systems. Magnetic resonance charging capabilities enable power transfer over longer distances without requiring precise landing alignment.

The charging interface in an embodiment must support various power levels to accommodate different drone battery capacities while enabling fast charging to minimize drone downtime. The system incorporates communication protocols allowing drones and charging stations to exchange battery status information, charging parameters, and safety checks. These protocols integrate with the drone-compatible control system to ensure proper charging operations.

Implementation considerations include safety features preventing overcharging and overheating, industry standardization requirements for interoperability, and environmental protection measures. The charging system's design accounts for various environmental conditions including rain, wind, dust, and temperature extremes. The self-aligning guides and automatic connection mechanisms ensure reliable charging engagement across different drone platforms.

Specific implementations in embodiments may include multiple USB-C ports with Power Delivery capability, allowing direct charging for compatible drones while providing adapter options for other connector types. For larger drones, rugged aviation-specific connectors with integrated CAN bus communication with specialized and standardized male and female connectors among the system and a drone enable high power transfer and sophisticated communication between drone and charging station. Smaller drone platforms may utilize Qi wireless charging with automated alignment systems ensuring optimal charging efficiency through multiple integrated charging pads.

The standardized charging connection may utilize industry-standard protocols such as USB-C Power Delivery or similar high-power charging standards. In an example of the invention, the connection point includes weather-protective covers that automatically open during charging operations and seal when not in use. The charging system may include power conditioning circuits to provide stable output voltage and current regardless of input power fluctuations. Advanced safety features may include ground fault detection, overcurrent protection, and thermal monitoring to prevent damage during charging operations.

For night-time power storage capability, a preferred embodiment incorporates advanced power management systems that optimize charging during daylight hours to ensure sufficient capacity for overnight operations. The system may include predictive algorithms to adjust charging patterns based on weather forecasts and historical usage data. The power management system may also incorporate load-shedding capabilities to prioritize critical functions during extended periods of limited solar collection. Additional features may include grid power backup options where available, with automatic switching between power sources to maintain uninterrupted operation. The system may also incorporate energy harvesting from alternative sources such as wind or kinetic movement to supplement solar collection during periods of limited sunlight.

The power management system may further include remote monitoring capabilities through cellular or wireless networks, enabling real-time status updates and performance optimization. Integration with smart home systems may allow users to monitor power usage, charging status, and system health through mobile applications or web interfaces. The system may also include automated maintenance scheduling based on usage patterns and component wear indicators, ensuring optimal performance throughout the system's operational life.

In a preferred embodiment of the invention, the drone resting/stabilization support comprises strategically positioned contact points near the top of the structure that provide temporary mechanical stability during package transfer operations. These supports may include cushioned rest pads constructed of durable elastomeric materials and configured to accommodate various drone form factors while preventing damage to both the drone and the structure. The stabilization system may incorporate visual guidance markers, proximity sensors, and automated positioning feedback to assist with precise drone positioning. The support system may also include retractable guide rails that extend during drone approach to provide additional stability during challenging weather conditions.

A critical and distinguishing structural feature of the automated package delivery and storage system relates to the physical location of the articulating mechanism and its associated drive components. In a preferred embodiment, the motorized winch system, including the electric drive motor, cable drums, cable routing pulleys, torque limiters, braking mechanisms, and position sensors, is housed entirely within or directly upon the dome-shaped roof structure, which is itself fixedly attached to the upper terminus of the vertical support structure. This architectural arrangement is referred to herein as a structural inversion, because the high-mass, electrically connected drive components remain permanently stationary at the top of the pole while the containment vessel, which is the only moving component along the vertical axis, carries no drive machinery and no live electrical connections associated with the articulating mechanism. Because the drive system is fixed at the top of the pole within the dome-shaped roof structure, all electrical wiring, motor leads, sensor connections, and power supply conductors terminate at a single static location. No flexible conduit, trailing cable, or moving electrical interface is required to deliver power to the articulating mechanism, thereby eliminating a primary source of mechanical wear and electrical failure that would otherwise result from repeated vertical translation cycles over the operational life of the system. A system in which the winch is mounted on the moving basket, or in which the motor is located at the ground-mounted base of the pole, would necessarily require electrical conductors that flex, extend, or slide with each actuation cycle, introducing fatigue failure modes and weather infiltration points that are absent from the present invention. In a preferred embodiment, the dome-shaped roof structure serves simultaneously as a mechanical housing for the drive system, a weather-resistant docking station that receives the containment vessel in its secured position, a mounting surface for the solar power collection system, and a structural platform for the drone charging interface. This concentration of functional elements in a single fixed structure at the upper terminus of the vertical support is a unitary design that positions all sensitive, heavy, and electrically connected equipment at the stationary top of the pole, maximizing system reliability and minimizing maintenance requirements. The cables or drive chains extending downward from the drum within the dome-shaped roof structure connect to the collar component, which is moveably coupled to the vertical support structure. Because the cables originate from within the fixed dome-shaped roof structure and descend along the interior or exterior of the vertical support structure to engage the collar, the load path of the containment vessel during all positions of vertical travel is fully governed by the fixed upper structure, ensuring that the weight of the containment vessel and any package contents is resolved through the dome-shaped roof structure and into the vertical support structure at all times.

The automated package delivery and storage system defines a minimum of three discrete vertical positions for the containment vessel, each corresponding to a distinct operational mode of the system. These positions are the secured docking position, the intermediate aerial delivery position, and the fully lowered ground delivery position. The existence of three operationally distinct positions, and the specific functional purpose assigned to each, constitutes a system architecture that enables the device to serve the distinct requirements of aerial delivery vehicles and ground delivery personnel through a single mechanical structure. The first position, referred to herein as the secured docking position, is the default resting state of the containment vessel. In this position, the containment vessel is raised to its maximum height along the vertical support structure and engages the dome-shaped roof structure through the weather-tight sealing interface. In the secured docking position, the containment vessel is mechanically locked or gravity-retained in sealed engagement with the dome-shaped roof structure, protecting package contents from precipitation, temperature extremes, and unauthorized access.

The second position, referred to herein as the intermediate aerial delivery position, is a programmed stop location along the vertical support structure at a height below the dome-shaped roof structure but substantially above ground level. In a preferred embodiment, the intermediate aerial delivery position is located at approximately eight to nine feet above the ground surface. This height is selected to place the upward-facing opening of the containment vessel within the operational envelope of an aerial delivery vehicle approaching from above, while simultaneously maintaining the containment vessel at an elevation that exceeds the practical unassisted reach of a person standing at ground level. The intermediate aerial delivery position therefore provides a security benefit during the aerial transfer event itself, ensuring that the package is not accessible by an unauthorized ground-level actor during the window in which the containment vessel is open and receiving a package from an aerial delivery vehicle. The intermediate aerial delivery position also addresses a specific aerodynamic consideration in drone operations. When an aerial delivery vehicle descends to deposit a package, ground effect turbulence intensifies as the vehicle approaches the ground surface. By receiving the aerial delivery at a height of approximately eight to nine feet above ground level, the system positions the containment vessel above the threshold at which ground effect aerodynamic interference would destabilize the aerial vehicle during the final phase of package transfer. This functional benefit is not achievable by a fixed ground-level or standard mailbox-height receptacle. The third position, referred to herein as the fully lowered ground delivery position, places the containment vessel at its maximum downward travel from the secured docking position, approximately three to four feet below the secured docking position. In a preferred embodiment, the fully lowered position maintains the containment vessel at a minimum height of approximately eight to nine feet above ground level, measured to the lower edge of the containment vessel. This height is intentionally maintained above the practical unassisted reach of an adult standing at ground level, providing a continuous theft-deterrent function even during ground-based delivery operations when the containment vessel is open to receive a package from a delivery driver.

The control system is configured to distinguish between actuation signals associated with aerial delivery operations and actuation signals associated with ground delivery operations, and to command the articulating mechanism to move the containment vessel to the appropriate discrete position for each operational mode. For aerial delivery operations, the control system commands the containment vessel to descend from the secured docking position to the intermediate aerial delivery position and to remain at that position until an aerial vehicle package transfer event is confirmed, after which the control system commands the containment vessel to return to the secured docking position. For ground delivery operations, the control system commands the containment vessel to descend from the secured docking position to the fully lowered ground delivery position and to remain at that position until a package has been deposited and the delivery event is completed, after which the control system commands the containment vessel to return to the secured docking position. The position sensors integrated into the vertical guide system provide real-time location data to the control system to enable precise stopping of the containment vessel at each of the three discrete positions. In a preferred embodiment, the position sensors include both primary and redundant sensing elements at each programmed stop position to ensure accurate positioning under all operating conditions, including variations in cable tension resulting from package weight and environmental temperature effects on cable elongation.

The weather-resistant construction, in an example of the invention, utilizes materials and assembly methods designed to withstand prolonged exposure to environmental conditions. The structure may incorporate marine-grade aluminum or stainless steel components with protective coatings, UV-resistant polymer materials, and sealed joints to prevent water intrusion. All external fasteners and hardware may be constructed of corrosion-resistant materials, with weatherproof gaskets at all access points and component interfaces. The construction may include multiple drainage channels and ventilation systems to prevent moisture accumulation while maintaining internal environmental stability. Advanced surface treatments and self-cleaning coatings may be applied to minimize maintenance requirements and extend operational life.

A preferred embodiment includes theft-deterrent features centered around the approximately twelve-foot height design, placing the containment vessel beyond practical reach without authorized access. The vertical support structure may incorporate smooth surfaces and anti-climbing features to prevent unauthorized access attempts. Additional security features may include motion sensors, cameras, and audible alarms to detect and deter tampering attempts. The security system may integrate with home security networks and include real-time notification capabilities. Tamper-evident markers and forensic tracking features may be incorporated to assist in security incident investigation.

The system's approximately twelve-foot height enables it to function as an elevated security sentry, providing enhanced surveillance capabilities for the property. From this vantage point, the system maintains a 360-degree view of the surrounding area, complementing its primary package delivery and storage functions with advanced security monitoring capabilities.

The elevated position places security features such as cameras and sensors at an optimal height for maximum coverage while remaining beyond practical reach of tampering attempts. This security sentry functionality enhances the system's existing theft-deterrent features by enabling comprehensive monitoring of the property from an elevated perspective that typical ground-based security systems cannot achieve.

When integrated with the system's other security features, including motion sensors and tamper-evident markers, the elevated sentry position creates a multi-layered security approach. The height advantage enables early detection of potential security threats while maintaining the system's primary function as a secure package delivery and storage solution.

The automated package delivery and storage system is configured as a fully self-contained, standalone assembly that requires no attachment to, penetration of, or structural modification of any existing building, wall, window, or roof surface. The entire system is supported by the ground mounting system at the base of the vertical support structure, and all functional components, including the articulating mechanism, the dome-shaped roof structure, the solar power collection system, the battery storage unit, the charging interface, and the control system, are integrated into the vertical support structure assembly and its associated cap and collar components. This standalone pole-mounted architecture provides a significant installation advantage over prior art systems that require mounting to building walls, window frames, or rooftop structures, which may cause structural damage, void building warranties, require landlord approval, or create aesthetic objections. The present invention may be installed in any location on a property where the ground mounting system can be established, including front yards, backyards, side yards, and access driveways, without any connection to the building structure. The standalone architecture also enables the system to be positioned at the location on the property that provides the most favorable aerial delivery vehicle approach path, rather than being constrained to the location of an existing building mounting point. In residential settings, the optimal aerial delivery vehicle approach path may be from a direction that does not correspond to any wall or window of the building, and the standalone pole-mounted system accommodates this requirement without modification. The system may be repositioned by removing and re-establishing the ground mounting system, providing flexibility for property owners who wish to change the delivery location over time.

The ground mounting system, in an example of the invention, includes a reinforced concrete foundation with embedded anchor points or a self-contained base plate system for surface mounting. The mounting system may incorporate leveling mechanisms to ensure proper vertical alignment during installation on uneven terrain. In one embodiment, the foundation system includes conduits for power and control wiring, as well as drainage features to prevent water accumulation around the base. The mounting system may include seismic stabilization features and ground fault protection circuitry. Advanced foundation designs may incorporate frost-heave prevention and soil stability monitoring to maintain structural integrity in various climate conditions.

Alternative mounting configurations in embodiments may utilize modular or pre-cast concrete bases manufactured off-site and delivered to the installation location. These pre-cast systems reduce on-site construction time while incorporating integrated anchor points, conduits, and leveling mechanisms for efficient installation.

For locations with suitable soil conditions, ground screw anchors in an embodiment provide a faster and less disruptive alternative to traditional concrete foundations. These screws are driven into the ground to provide stable support while maintaining easier removal capabilities if system relocation becomes necessary. A hybrid approach may combine ground screws with a smaller concrete pad, where the screws provide primary anchoring while the concrete pad ensures a level mounting surface.

The system in an embodiment may alternatively utilize ballast blocks constructed from concrete or other dense materials to provide stabilization without requiring deep foundations. This configuration particularly suits temporary installations or locations where excavation proves challenging. An adjustable base plate system incorporating legs or outriggers can accommodate uneven terrain while eliminating precise leveling requirements during installation.

For building-mounted installations, the system in an embodiment may attach directly to walls using heavy-duty brackets and anchors, requiring careful assessment of structural integrity and compliance with local building codes. Roof mounting configurations for buildings with flat roofs can utilize similar mounting systems to solar panel installations, incorporating appropriate waterproofing and roof penetration protection.

The system in an embodiment may alternatively mount to existing structures such as utility poles or light poles, requiring specialized mounting hardware and electrical safety considerations. For new construction projects, the delivery system can integrate directly into the building's design, allowing seamless integration and optimized placement of the landing platform.

In embodiments, the mounting configurations account for wind loading requirements, particularly in exposed locations, while incorporating appropriate corrosion resistance measures to withstand environmental conditions. The mounting system design facilitates maintenance access while maintaining aesthetic appeal and minimizing environmental impact. Installation requires appropriate permits and approvals from local authorities while considering specific site conditions and requirements.

The package protection enclosure, in a preferred embodiment, provides protection through multiple integrated features. The enclosure may include impact-absorbing materials, water-channeling designs to direct precipitation away from contents, and thermal insulation properties to protect temperature-sensitive items. The protection system may incorporate anti-tampering features such as reinforced access points and secure latching mechanisms that engage automatically when the containment vessel reaches its secured position. Additional features may include internal environmental monitoring sensors and automatic ventilation systems to maintain appropriate conditions for package storage. The enclosure may also incorporate antimicrobial surfaces and air filtration systems to protect package contents from environmental contaminants. Smart sensing capabilities may detect package conditions and adjust environmental controls accordingly, while maintaining an event log of all access and environmental changes.

While various modifications and alternative forms of the invention are contemplated, specific examples thereof have been shown in the drawings and are herein described in detail. It should be understood, however, that the invention is not limited to the particular forms or methods disclosed, but rather covers all modifications, equivalents, and alternatives falling within the spirit and scope of the appended claims. While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. An automated package delivery and storage system comprising: a vertical support structure extending upward from a ground surface and fixedly mounted to a ground mounting system at a lower terminus; a dome-shaped roof structure fixedly attached to an upper terminus of the vertical support structure; an articulating mechanism housed within the dome-shaped roof structure, the articulating mechanism comprising a drive motor, a cable drum driven by the drive motor, and at least one cable extending downward from the cable drum along the vertical support structure, wherein all electrical connections associated with the articulating mechanism terminate at the dome-shaped roof structure and remain stationary during all positions of vertical travel of a containment vessel; a collar moveably coupled to the vertical support structure and operatively connected to the at least one cable such that actuation of the drive motor produces vertical translation of the collar along the vertical support structure; a containment vessel affixed to the collar and configured to travel vertically with the collar between a secured docking position and at least one lowered position; a weather-tight sealing interface formed by complementary mating surfaces on an upper perimeter of the containment vessel and on a lower receiving surface of the dome-shaped roof structure, the sealing interface being completed by upward movement of the containment vessel to the secured docking position without requiring independent actuation of a separate cover mechanism; and a control system configured to receive wireless authentication signals and to command the articulating mechanism to move the containment vessel to selected vertical positions responsive to received signals.

2. The system of claim 1, wherein the vertical support structure extends approximately twelve feet in height from the ground surface, placing the containment vessel at an elevation that exceeds the practical unassisted reach of an adult standing at ground level in all positions of vertical travel.

3. The system of claim 1, wherein the control system is configured to command the articulating mechanism to stop the containment vessel at a minimum of three discrete vertical positions comprising: a secured docking position at which the containment vessel engages the dome-shaped roof structure to complete the weather-tight sealing interface; an intermediate aerial delivery position below the secured docking position and at a height of approximately eight to nine feet above the ground surface, selected to position the containment vessel within the operational envelope of an aerial delivery vehicle while maintaining the containment vessel above the practical unassisted reach of an adult standing at ground level; and a fully lowered ground delivery position below the intermediate aerial delivery position, wherein the fully lowered ground delivery position maintains the containment vessel at a minimum height of approximately eight to nine feet above the ground surface measured to a lower edge of the containment vessel.

4. The system of claim 3, wherein the control system is configured to distinguish between an aerial delivery actuation signal and a ground delivery actuation signal and to command the articulating mechanism to move the containment vessel to the intermediate aerial delivery position responsive to the aerial delivery actuation signal and to the fully lowered ground delivery position responsive to the ground delivery actuation signal.

5. The system of claim 1, further comprising: a solar power collection system comprising photovoltaic panels mounted on the dome-shaped roof structure; a battery storage unit housed within the vertical support structure and electrically coupled to the solar power collection system, the battery storage unit configured to maintain system operation for a minimum of seventy-two hours without solar energy input; and a drone charging interface mounted on or proximate to the dome-shaped roof structure and electrically coupled to the battery storage unit, the drone charging interface configured to provide electrical power to aerial delivery vehicles docked at or near the dome-shaped roof structure.

6. The system of claim 5, wherein the drone charging interface is configured to support at least two of the following charging protocols: USB-C Power Delivery at up to 240 watts; an aviation-specific wired connector with integrated CAN bus communication; Qi inductive charging; and Rezence resonant inductive coupling.

7. The system of claim 5, wherein the solar power collection system, the battery storage unit, and the drone charging interface are integrated into the vertical support structure assembly and the dome-shaped roof structure as a self-contained power architecture requiring no electrical connection to a building.

8. The system of claim 1, wherein the weather-tight sealing interface comprises: a first sealing surface defined by an upper perimeter geometry of the containment vessel; a second sealing surface defined by a receiving geometry on a lower face of the dome-shaped roof structure; and a compressible gasket element retained between the first sealing surface and the second sealing surface and compressed when the containment vessel is in the secured docking position, creating a continuous seal around the entire perimeter of the containment vessel opening.

9. The system of claim 1, wherein the control system comprises: a first wireless receiver configured to authenticate signals from a handheld FOB device operating at 315 MHz or 433 MHz with rolling-code 128-bit encryption; a second wireless receiver configured to authenticate signals from a mobile device application; and a third wireless receiver configured to authenticate signals from an aerial delivery vehicle.

10. The system of claim 1, further comprising: position sensors integrated into the vertical support structure and configured to monitor the vertical location of the containment vessel and provide position feedback to the control system for precise stop positioning at each discrete vertical position, the position sensors comprising primary and redundant sensing elements at each programmed stop position.

11. The system of claim 1, further comprising: stabilization supports positioned proximate to the dome-shaped roof structure, the stabilization supports comprising cushioned rest pads configured to provide temporary mechanical support for aerial delivery vehicles during package transfer and charging operations; and visual alignment markers mounted on at least one of the containment vessel and the dome-shaped roof structure, the visual alignment markers comprising at least one of QR codes, ArUco markers, and retroreflective geometric patterns configured to provide landing guidance to aerial delivery vehicle camera systems.

12. The system of claim 11, further comprising radio frequency positioning beacons integrated into the dome-shaped roof structure and configured to provide location signals to aerial delivery vehicles at ranges exceeding visual detection range of the visual alignment markers, the radio frequency positioning beacons comprising at least one of an Ultra-Wideband beacon, a Bluetooth Low Energy beacon, and an RFID tag.

13. The system of claim 1, wherein the vertical support structure is a self-contained standalone assembly fixedly mounted to the ground mounting system and configured for installation without attachment to, penetration of, or structural modification of any building wall, window, or rooftop surface, and wherein the ground mounting system comprises a reinforced concrete foundation with embedded anchor points and conduits for power and control wiring integrated within the vertical support structure between the ground mounting system and the dome-shaped roof structure.

14. The system of claim 1, wherein the articulating mechanism further comprises: precision-machined guide rails or channels integrated into or along the vertical support structure and configured to maintain alignment of the collar and containment vessel during vertical travel; redundant cable support configured to prevent uncontrolled descent of the containment vessel in the event of a primary cable failure; and programmable acceleration and deceleration profiles configured to minimize mechanical wear during actuation.

15. An automated package delivery and storage system comprising: a vertical support structure extending approximately twelve feet in height from a ground mounting system; a dome-shaped roof structure fixedly attached to an upper terminus of the vertical support structure; an articulating mechanism housed entirely within the dome-shaped roof structure and comprising a motorized drive system, wherein all electrical connections associated with the articulating mechanism terminate at the dome-shaped roof structure and no electrical connections associated with the articulating mechanism flex or travel during vertical translation of a containment vessel; a collar moveably coupled to the vertical support structure; a containment vessel affixed to the collar and configured to stop at a minimum of three discrete vertical positions comprising a secured docking position, an intermediate aerial delivery position at approximately eight to nine feet above the ground surface, and a fully lowered ground delivery position maintaining the containment vessel at a minimum of approximately eight to nine feet above the ground surface measured to a lower edge of the containment vessel; a weather-tight sealing interface completed automatically by upward movement of the containment vessel to the secured docking position without independent actuation of a separate cover mechanism; a solar power collection system integrated into the dome-shaped roof structure; a battery storage unit integrated into the vertical support structure and configured to maintain system operation for at least seventy-two hours without solar input; a drone charging interface integrated into or proximate to the dome-shaped roof structure and configured to support multiple aerial vehicle charging protocols; and a control system configured to distinguish between aerial delivery operational mode and ground delivery operational mode and to command the articulating mechanism to move the containment vessel to the intermediate aerial delivery position for aerial delivery operations and to the fully lowered ground delivery position for ground delivery operations.

16. A method of operating an automated package delivery and storage system comprising a vertical support structure having a dome-shaped roof structure fixed at an upper terminus, a containment vessel moveably coupled to the vertical support structure, and an articulating mechanism housed within the dome-shaped roof structure with all electrical connections associated with the articulating mechanism terminating at the dome-shaped roof structure, the method comprising: maintaining the containment vessel in a secured docking position in which the containment vessel engages the dome-shaped roof structure to form a weather-tight seal; receiving a wireless authentication signal from an authorized aerial delivery vehicle; commanding the articulating mechanism to lower the containment vessel from the secured docking position to an intermediate aerial delivery position at approximately eight to nine feet above ground level; receiving a package deposited into the containment vessel through an upward-facing opening by the aerial delivery vehicle while the containment vessel is at the intermediate aerial delivery position; commanding the articulating mechanism to raise the containment vessel from the intermediate aerial delivery position to the secured docking position, thereby completing the weather-tight seal and securing the package; and maintaining the containment vessel in the secured docking position until a subsequent authorized retrieval signal is received.

17. The method of claim 16, further comprising: receiving a wireless authentication signal from authorized ground delivery personnel; commanding the articulating mechanism to lower the containment vessel from the secured docking position to a fully lowered ground delivery position that is lower than the intermediate aerial delivery position and that maintains the containment vessel at a minimum of approximately eight to nine feet above the ground surface measured to a lower edge of the containment vessel; receiving a package deposited into the containment vessel by the ground delivery personnel; and commanding the articulating mechanism to raise the containment vessel to the secured docking position upon confirmation of package deposit.

18. The method of claim 16, further comprising: collecting solar energy through photovoltaic panels mounted on the dome-shaped roof structure; storing collected solar energy in a battery storage unit integrated into the vertical support structure; providing electrical charging power to the aerial delivery vehicle through a drone charging interface mounted on or proximate to the dome-shaped roof structure while the containment vessel is in the secured docking position; and managing stored energy to maintain system operation for a minimum of seventy-two hours without solar energy input.

19. The method of claim 16, further comprising: guiding the aerial delivery vehicle to the containment vessel using a multi-stage navigation sequence comprising navigating to GPS coordinates associated with the vertical support structure, detecting a radio frequency positioning beacon integrated into the dome-shaped roof structure, and identifying a visual alignment marker on the containment vessel using a camera system of the aerial delivery vehicle for precise positioning over the upward-facing opening.

20. The method of claim 16, wherein commanding the articulating mechanism to lower the containment vessel to the intermediate aerial delivery position comprises detecting arrival of the containment vessel at the intermediate aerial delivery position using position sensors integrated into the vertical support structure and commanding the articulating mechanism to stop, wherein the position sensors comprise primary and redundant sensing elements at the intermediate aerial delivery position to ensure accurate positioning under all operating conditions.
